(19) United States
(12) Patent Application Publication
(10) Pub. No.: US 2013/0262864 A1
(43) Pub. Date: Oct. 3, 2013

(54) METHOD AND SYSTEM FOR SUPPORTING SECURE DOCUMENTS

(71) Applicant: IMATION CORP., Oakdale, MN (US)

(72) Inventor: Laurence Hamid, Ottawa (CA)

(73) Assignee: Imation Corp., Oakdale, MN (US)

(21) Appl. No.: 13/838,240

(22) Filed: Mar. 15, 2013

Related U.S. Application Data
(60) Provisional application No. 61/619,687, filed on Apr. 3, 2012.

(51) Int. Cl. G06F 21/62

(52) U.S. Cl. CPC G06F 21/6218
USPC 713/165; 713/189

(57) ABSTRACT

A secure document is formed having a first secure section for being accessed by a first target. The first secure section includes encrypted data displayable within the document and for forming part of the displayed secure document. The secure document also includes a first security section for use in decrypting of the first secure section. The first security section has first section security data secured therein by first target security data that is accessible to the first target. Also, the first section security section is for being displayed within the document. Another secure document is formed having a reference to secure content, which reference can be decoded, whereupon a user can be authenticated, and the secure content downloaded and viewed by the authenticated user.

This application claims priority to U.S. provisional application No. 61/619,897, filed Apr. 3, 2012, the content of which is incorporated herein by reference in its entirety.

### FIELD OF THE INVENTION

The invention relates to document security and more particularly to documents for distribution and review by numerous parties that are secured.

### BACKGROUND

Wikileaks has made considerable headlines of late by publishing a large volume of confidential documents and making them available to the public. This has resulted in embarrassment and security concerns for the United States, for example. New and improved processes to prevent leaks are being sought.

Unfortunately, there is no present day methodology for preventing documents from being leaked out of an organization other than physical security. Though physical security is sometimes sufficient, it presents a series of difficulties in today's world of travel and multi-office work environments.

It would be advantageous to overcome at least some of the shortcomings of the prior art.

### SUMMARY OF THE INVENTION

According to an aspect of at least one embodiment of the invention there is provided a secure document comprising a first secure section for being accessed by a first target, the first secure section having therein encrypted data displayable within the secure document and for forming part of the displayed secure document; and a first security section for use in decrypting of the first secure section, the first security section having first section security data secured therein by first target security data, the first target security data accessible to the first target, and the first security section for being displayed within the secure document.

According to an aspect of at least one embodiment of the invention there is provided a method comprising providing a secure document comprising a first secure section for being accessed by a first target having therein encrypted data displayable within the document and for forming part of the displayed document; and a first security section for use in decrypting of the first secure section, the first security section having first section security data secured therein by first target security data, the first target security data accessible to the first target and the first security section for being displayed within the secure document.

According to an aspect of at least one embodiment of the invention there is provided a method comprising providing a first user key for a first user for encryption and decryption of first text in a first document; providing a second user key for a second user for encryption and decryption of second text in the first document; providing a printable format of the first document other than a format comprising a first section encrypted using the first user key and a second section encrypted using the second user key; decrypting the first text in the first document using the first user key; displaying the decrypted first text to the first user and displaying encrypted second text to the first user; decrypting the second text in the first document using the second user key; displaying the decrypted second text to the second user and displaying encrypted first text to the second user.

According to an aspect of at least one embodiment of the invention there is provided a method comprising obtaining, by a mobile device, a graphical encoding of a reference to secure content, decoding that reference, sending a message to a remote server requesting that secure content, authenticating a user to said remote server with respect to that secure content, and retrieving information sufficient to view said secure content at said mobile device.

### BRIEF DESCRIPTION OF THE DRAWINGS

The features and advantages of the embodiments of the invention will become more apparent from the following detailed description, with reference to the attached figures, wherein:

FIG. 1 shows a prior art document for management in a document management system.

FIG. 2 shows a method of securing the document of FIG. 1.

FIG. 3 shows another method of securing the document of FIG. 1.

FIG. 4 shows a printed document according to an embodiment of the present invention.

FIG. 5 shows an electronic version of the document of FIG. 4.

FIG. 6 shows a method for generating section keys for a document according to an embodiment of the present invention.

FIG. 7 shows another method for generating section keys for a document according to an embodiment of the present invention.

FIG. 8 shows yet another method for generating section keys for a document according to an embodiment of the present invention.

FIG. 9 shows a more complex secured document having 5 target identifiers associated with 5 targets.

FIG. 10 shows a method for reading a document according to an embodiment of the invention

FIG. 11 shows a method for reading a partially secured document according to an embodiment of the invention.

FIG. 12 shows a simplified flow diagram for a process for document management of a secure document such as that of FIG. 6.

FIG. 13 is a simplified block diagram of a system for enhanced security of a target's secret key.

FIG. 14 shows a method for reading the document of FIG. 4.

FIG. 15 shows a document wherein section keys are secured and stored at a single location within the document.

FIG. 16a shows a secure section of a document represented by a non-textual graphical image.

FIG. 16b shows a secure document including a non-textual graphical image representing encrypted text.

FIG. 17a shows a secure section of a document represented by a non-textual graphical image in the form of a one dimensional bar code.

FIG. 17b shows a simplified block diagram of a system for enhanced security of a target's secret key.

FIG. 17c shows a simplified block diagram of a system including remote access of a secure document.

FIG. 18 shows a method for reading the document of FIG. 4.

FIG. 19a shows a secure document wherein each section comprises watermark 1901.

FIG. 19b shows a secure document wherein each section comprises unique watermarks.

FIG. 20 shows a prior art system for sharing a document.

FIG. 21 shows a system for sharing a secure document according to an embodiment of the invention.

FIG. 22 is a simple block diagram of a system for generating the document of FIG. 21.

FIG. 23 is a simple block diagram of another method for generating the secure document of FIG. 21.

FIG. 24 is a simple network block diagram of a system for sharing a secure document according to an embodiment of the invention.

FIG. 25 shows a method of generating and retrieving the secure document in FIG. 24.

FIG. 26 shows another system for generating and retrieving the secure document in FIG. 24.

FIG. 27 shows a conceptual drawing of a printed document according to another embodiment.

FIG. 28 shows a conceptual drawing of a system capable of retrieving secure content.

FIG. 29 shows a conceptual drawing of a method of retrieving secure content.

### DETAILED DESCRIPTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed, but is to be accorded the widest scope consistent with the principles and features disclosed herein.

### DEFINITIONS

Cipher is a general term for transforming plain text wherein the plain text is obfuscated and cannot easily be transformed back to plain text absent further information.

Encryption is a form of cipher wherein a secret key is used with a known process in order to obfuscate the data in a reversible fashion. Encryption is useful for securing data from unauthorized access and for indicating an origin of data when used for digitally signing.

Plain text is data that is other than in a ciphered form.

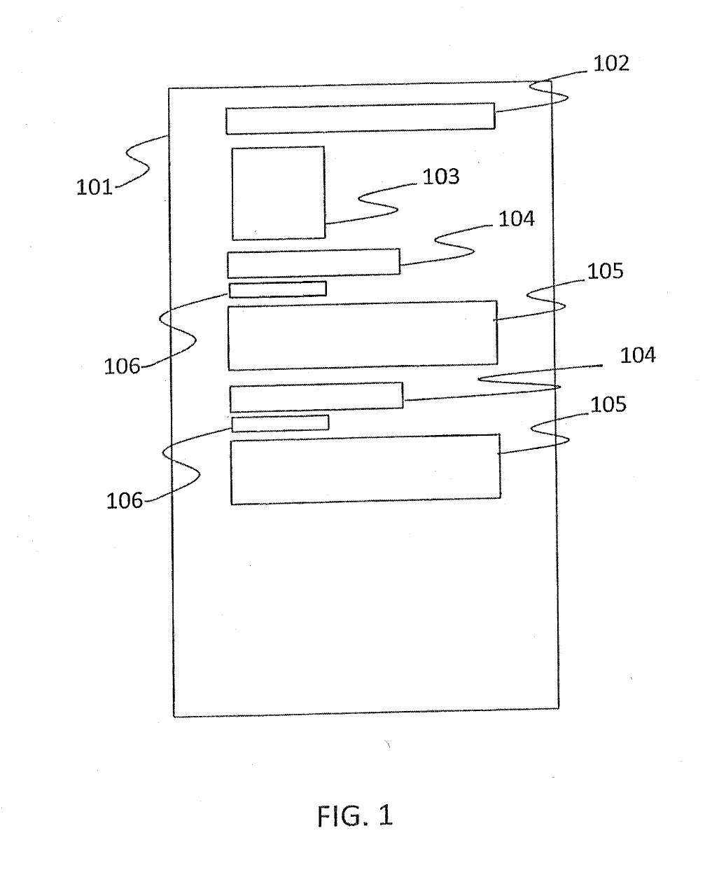

Referring to FIG. 1, shown is a prior art document 101 for management in a document management system. The document comprises a title 102, table of contents 103, section headings 104, and a plurality of section contents 105. Optionally, the section contents include subsections 106. Document 101 is an electronic document. Of course, document 101 could also be a printed document stored in a file or within a filing system.

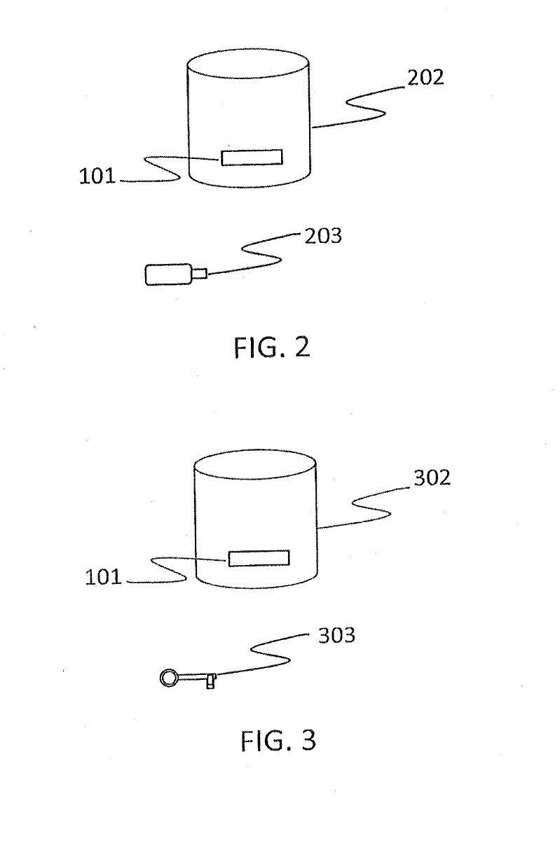

Referring to FIG. 2, a method of securing the document 101 of FIG. 1 is shown. The document 101 is stored electronically, for example as a PDF document. The PDF document is stored within a secure server 202 to which access is restricted based on target authentication. Such a security system limits access to a document and, as such, is commonly used. Unfortunately, once an authorized individual accesses such a document, they are free to distribute the document to others by copying it to a portable storage device, for example a USB memory device 203, and then either displaying it from the portable storage device or transferring it to another target therefrom.

Referring to FIG. 3, another method of securing the document 101 of FIG. 1 is shown. The document 101 is stored electronically, for example as a PDF document, in server 302. The PDF document is then encrypted using a shared secret key 303. For example, a data encryption standard (DES) key shared by an organization. Then, anyone in the organization can decrypt the document 101 and view it or print it. Alternatively, the document 101 is encrypted separately for each recipient using a public key section of a private-public key pair associated with that recipient.

The encryption of documents is often used to secure said documents during transport or transmission. It allows an electronic document to pass through unsecure media in transmission from a first secure location to another. Further, it allows for offsite secure storage of documents.

As will be understood, once the document is decrypted, whether stored locally, printed and placed in a file, or distributed, the document is now secured merely by physical security. Unfortunately, once the document is printed or stored in plain text, it is now susceptible to industrial espionage and content leaks when physical security fails or is circumvented. Prior art methods for avoiding security breaches include physical security devices—locked file cabinets, locked doors, locked buildings; physical surveillance—security guards, cameras; and other more extreme methods such as vaults and military perimeters. As will be apparent from the recent flood of Wikileaks documents, none of these are sufficient in today's world of digital electronics.

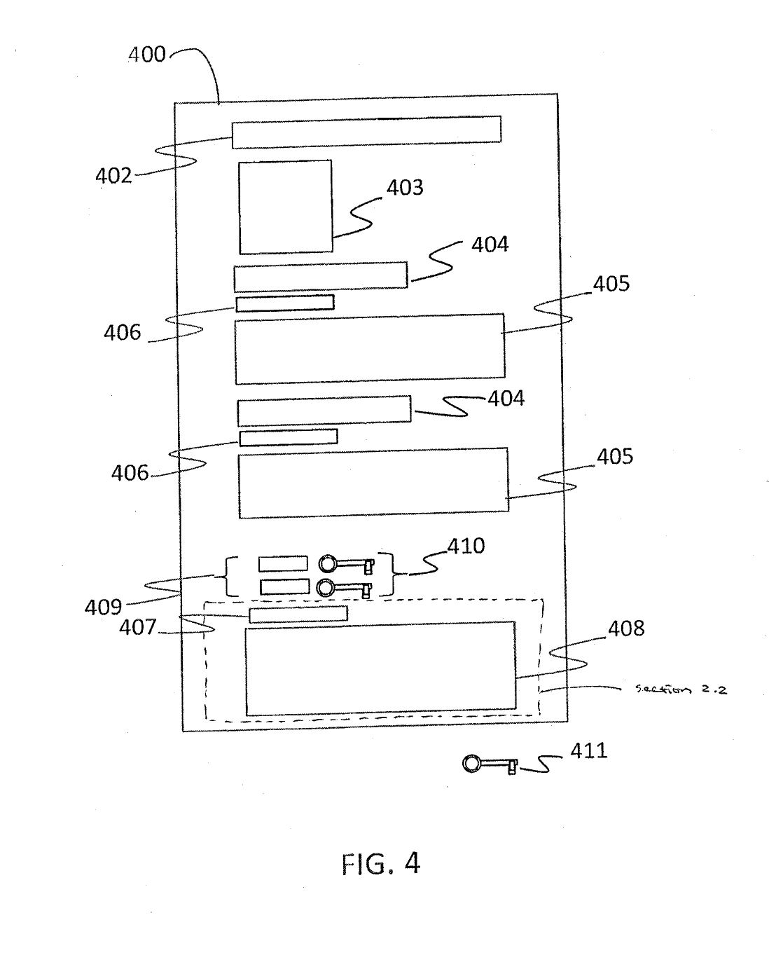

Referring to FIG. 4, shown is a printed document 400 according to an embodiment of the present invention. Once again, the document is shown similarly to the document of FIG. 1 having a title 402, table of contents 403, section headings 404, subsections 406, and a plurality of section contents 405. The document is shown with section 2.2 having a title 407 and contents 408 that are secured. Here, section 2.2 begins with a series of target identifiers in the form of target names 409 and for each such target identifier a section key 410 is included. The section key 410 is secured in accordance with a secret key 411 accessible to each target, wherein a target is a person having a secret key to decode a section key for deciphering the section. Section 2.2 is then ciphered in accordance with the section key 410 and stored within the document. Thus, by deciphering the section key 410 using the secret key 411, the target is provided access to the section key 410 to decipher section 2.2. Scanning and image-to-text processing is performed in order to allow for a simple electronic process to perform the deciphering. However, once a section of text is decrypted the text is no longer secure. Optionally, document 400 comprises unencrypted plain text that is readable by all targets, including targets other than having a section key. Optionally, decrypted text is legible text for reading by the target. Optionally, error detection and correction encoding is used to assist in the scanning and image-to-text processing that is performed. Optionally, when printing a secure document wherein a secure section is decrypted, the secure section is printed encrypted. Further optionally, when printing a secure document wherein a secure section is decrypted, the decrypted secure section is other than printed.

As is evident, each section is secured with a different section key. Alternatively, two or more sections are secured with a same section key. As the section key is secured with a secret key, as many or as few individuals are provided access to the data. Further, the document is stored within files, on desktops, in briefcases, and so forth, in a secure but accessible fashion.

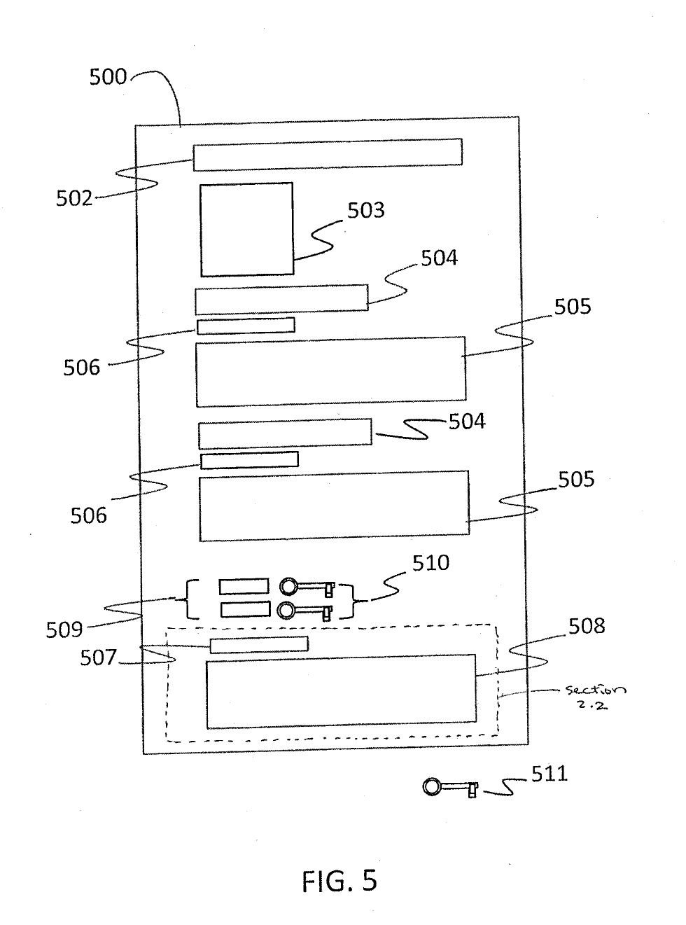

Referring to FIG. 5, shown is an electronic version 500 of document 400. The document is shown similarly to the document of FIG. 4 having a title 502, table of contents 503, section headings 504, subsections 506, and a plurality of section contents 505. The document is shown with section 2.2 having a title 507 and contents 508 that are secured. Here, section 2.2 begins with a series of target identifiers in the form of target names 509 and for each such target identifier a section key 510 is included. The section key 510 is secured in accordance with a secret key 511 accessible to each target. Section 2.2 is then ciphered in accordance with the section key 510 and stored within the document. Thus, by deciphering the section key 510 using the secret key 511, the target is provided access to the section key 510 to decipher section 2.2. Optionally, document 500 comprises unencrypted plain text that is readable by all targets, including targets other than having a section key.

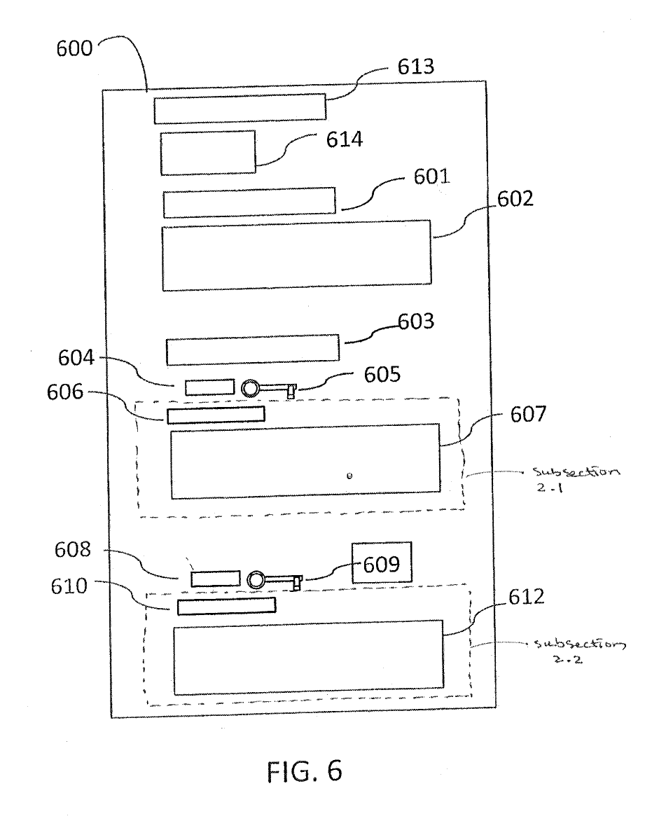

Referring to FIG. 6, shown is a method for generating section keys for document 600. Document 600 is generated in accordance with the prior art and comprises a title 613, a table of contents 614, a first section heading 601, first section contents 602, a second section heading 603, subsection 2.1 heading 606, subsection 2.1 contents 607, subsection 2.2 heading 610, and subsection 2.2 contents 612. Once document 600 is generated, or during generation thereof, section 2.1 is associated with a first target and section 2.2 is associated with a second target. A first section key is generated for a first target identifier 604 and a second section key is generated for a second target identifier 608 for securing section 2.1 and section 2.2, respectively. The first target has access to section 2.1 only and the second target has access to section 2.2 only. Section 2.1 key and section 2.2 key are then encrypted and stored within the document, along with the corresponding target identifiers, immediately preceding the sections they secure. For example, encrypted keys 605 and 609 are stored within document 600 immediately preceding subsection heading 606 and subsection heading 610. Once all sections having a target identifier are secured, the document is stored and/or printed in order to form a document similar to FIG. 5 and/or FIG. 4, respectively.

Alternatively, encrypted keys 605 and 609 are stored within the document elsewhere, such as within the table of contents 614 or title 613. Storing an encrypted section key and target identifier immediately preceding the section with which they are associated, eases the process of copying a section from one document and pasting it into another. During the copying process, the encrypted section key need not be searched for in other parts of a first document as the encrypted key, target identifier and section contents are spatially close to one another in the document. During the pasting process, the copied information, the encrypted key, the target identifier and the section contents, are pasted into a second document and no other sections of the document need to be modified. For example, in documents where encrypted section keys are located in the title, the title will be modified to include the new encrypted section key.

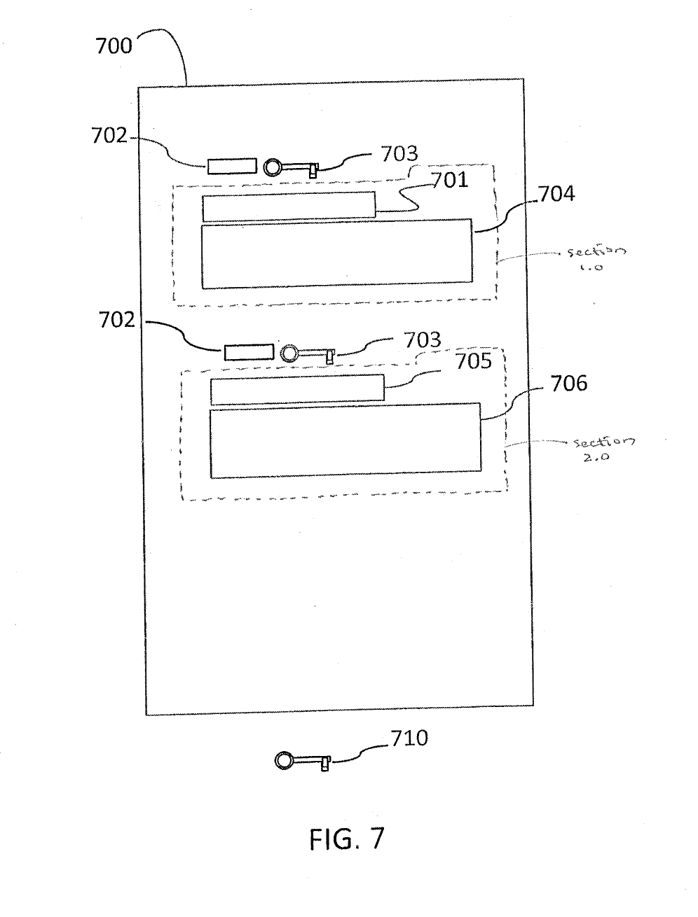

Referring to FIG. 7, shown is a method for generating section keys for document 700. Document 700 is generated in accordance with the prior art and comprises a section 1.0 heading 701, target identifier 702, section 1.0 contents 704, section 2.0 heading 705, target identifier 702, section 2.0 contents 706. Sections 1.0 and 2.0 are to be accessible to a group of targets wherein each target in the group has access to the same secret key 710. Once document 700 is generated, or during generation thereof, sections 1.0 and 2.0 are associated with the same target group. Both section 1.0 and section 2.0 have the same target identifier. One section key 703 is generated for securing both sections, section 1.0 and section 2.0. Section 1.0 key and section 2.0 key are then encrypted and stored within the document, along with the corresponding target identifiers, immediately preceding the sections they secure. For example, encrypted key 703 is stored within document 700 immediately preceding headings 701 and 705. Once all sections having a target identifier are secured, the document is stored and/or printed in order to form document 700. Alternatively, another target or target group has access to section 1, section 2 or both sections in document 700.

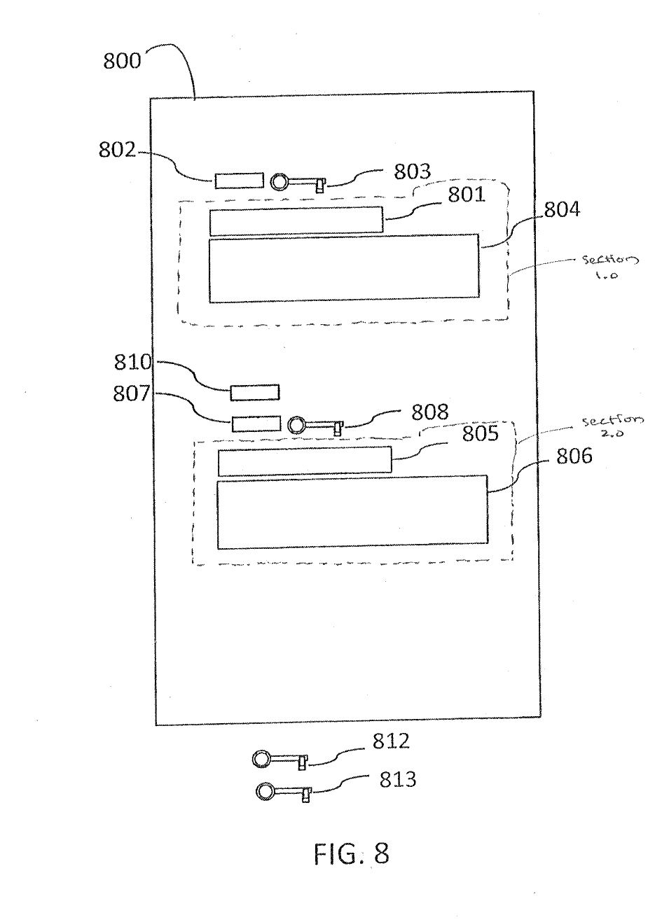

Referring to FIG. 8, shown is a method for generating section keys for document 800. Document 800 is generated in accordance with the prior art and comprises a section 1.0 heading 801, target group identifier 802, section 1.0 contents 804, section 2.0 heading 805, target group identifiers 807 and 810, and section 2.0 contents 806. Once document 800 is generated, or during generation thereof, section keys are generated for securing associated sections. In this example, section 1.0 is associated with target identifier 802 and section 2.0 is associated with target identifier 807 and target identifier 810. Section key 803 is generated for securing section 1.0 and then encrypted using secret key 812. Section key 808 is generated for securing section 2.0 and then encrypted using secret key 812 where target group identifier 810 is associated therewith. Furthermore, section key 808 is encrypted a second time using secret key 813 wherein target group identifier 807 is associated therewith. In this example a first target has access to secret key 813 and target identifiers 802 and 810 are the same, providing the first target access to both section 1.0 and section 2.0. Alternatively, a second target has access to secret key 812 and target identifiers 802 and 810 are other than the same. The first target has access to the section 1.0 and other than access to section 2.0. Furthermore, the second target has access to the section 2.0 and other than access to section 1.0. Then the section keys are stored along with the corresponding target identifiers within the document immediately preceding the sections they secure. For example, encrypted key 803 is stored within document 800 immediately preceding heading 801 and encrypted key 808 is stored within document 800 immediately preceding heading 805. Once all sections having a target identifier are secured, the document is stored and/or printed in order to form document 800.

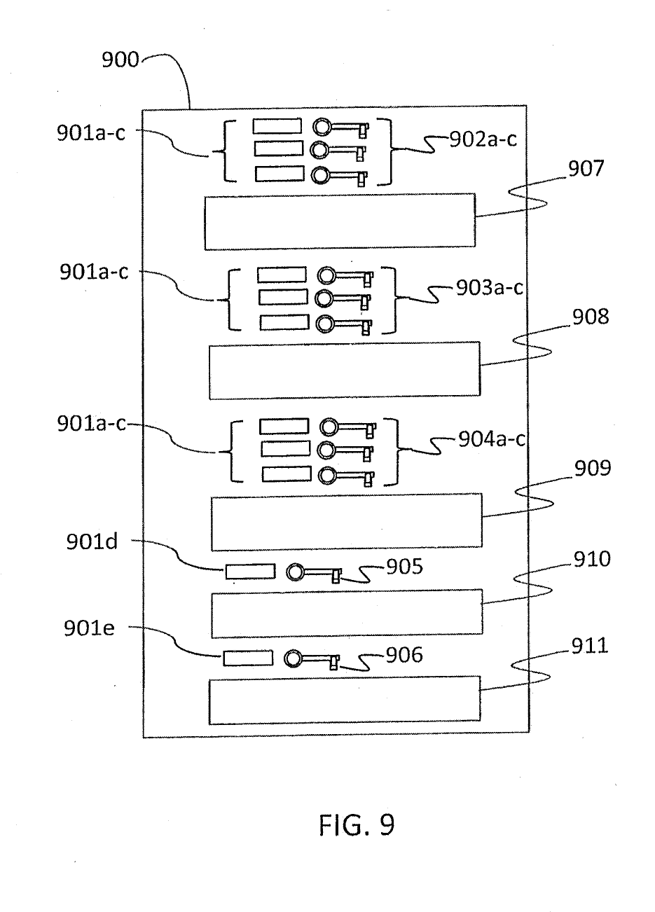

Referring to FIG. 9, a more complex secured document 900 is shown having 5 target identifiers 901a-e associated with 5 targets. Three of the 5 target identifiers, 901a-c, have access to sections 907, 908 and 909 within the secured document 900. For example, the section keys for target identifier 901a are 902a, 903a and 904a for sections 907-909 respectively. Similarly, for sections 907-909, the section keys for target identifier 901b are 902b, 903b and 904b, respectively, and the section keys for target identifier 901c are 902c, 903c and 904c, respectively. Sections 910 and 911 are inaccessible to targets associated with target IDs 901a-c. Target identifier 901d has access to section 910 only of document 900 via section key 905. Similarly, target identifier 901e has access to section 911 only of the document 900 via section key 906. Optionally, document 900 comprises unencrypted plain text that is readable by all targets, including targets other than having a section key. Optionally, a group of targets shares a secret key. For example, each group of three targets has a group secret key as might be the case if the section keys were associated with organizations and/or departments.

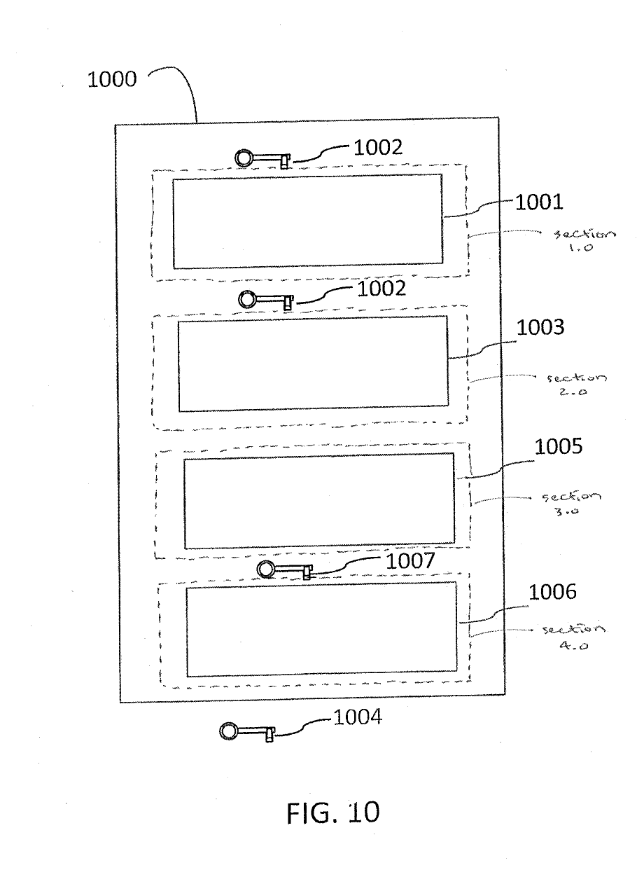

Referring to FIG. 10, shown is a simple method for reading the document 1000 according to an embodiment of the invention. A target highlights section 1.0 contents 1001 comprising encrypted text and right clicks with their mouse. Alternatively, another method of bringing up an actions menu is employed. The target selects decrypt text and the encrypted text associated with the target is decrypted within document 1000. Optionally, document 1000 is locked to prevent printing, or saving thereof, when secure section 1.0 contents 1001 are decrypted and displayed in plain text. The target decrypts those sections of the document for which the target has access to a section key, for example, section 1.0 contents 1001 and section 2.0 contents 1003, and thereby has access to all sections of the document that are unsecured—in plain text, for example section 3.0 contents 1005—and those secured for the target's access, for example section 1.0 contents 1001 and section 2.0 contents 1003—wherein the section key is secured with the target's secret key 1004. Once sections 1.0 and 2.0 contents are unsecured the target prints document 1000. However, section 4.0 contents 1006 is secured with section key 1007 and is other than decrypted. When document 1000 is printed section 4.0 contents 1006 is unreadable and thus a complete leak of the document 1000 contents is averted. Further, should the target decide to leak electronic document 1000 as received, the secure sections remain secure. The unsecured plain text in section 3.0 contents 1005 is readable by all targets, including targets other than having a section key. Once a section of text is decrypted, the text is no longer secure. Optionally, decrypted text is legible text for reading by the target. Optionally, when printing a secure document wherein a secure section is decrypted, the secure section is printed encrypted. Further optionally, when printing a secure document wherein a secure section is decrypted, the decrypted secure section is other than printed.

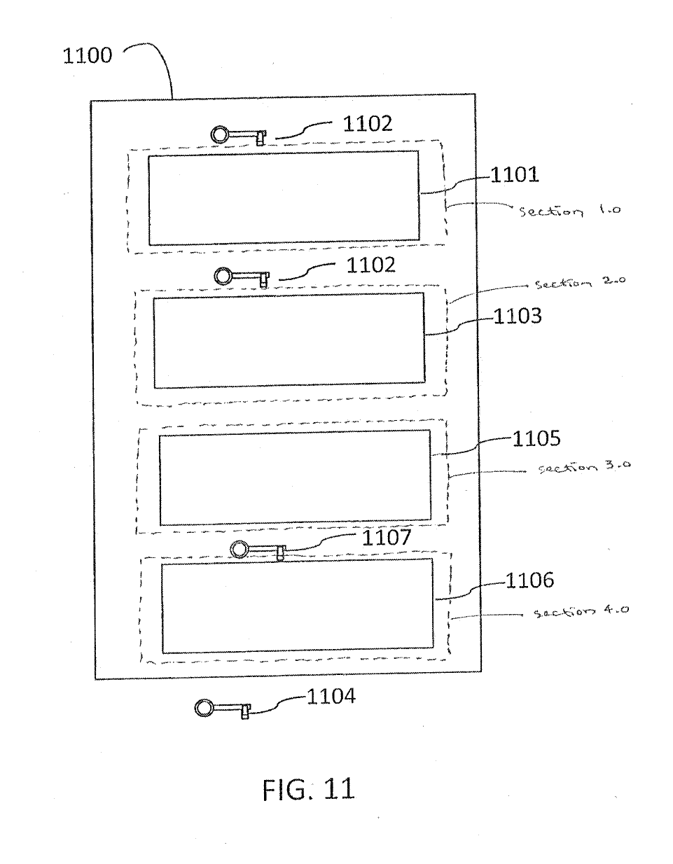

According to another embodiment of the invention a simple method for reading a partially secured document is shown in FIG. 11. A target opens document 1100 and highlights a section of the document that is encrypted, for example secure section 1.0 contents 1101 and right clicks with their mouse. Alternatively, another method of bringing up an actions menu is employed. The target selects decrypt text and the secure section 1.0 contents is decrypted and displayed within a separate window overlaid on the encrypted text. For example decrypted section 1.0 contents is displayed in a window on top of encrypted section 1.0 contents within document 1100. Optionally, the overlaid window is locked to prevent printing or saving thereof other than having a section key. Alternatively, the target opens document 1100 in a software application, for example Adobe Acrobat®, and upon authentication of the target by the software application the encrypted text associated with the target is decrypted. Further alternatively, the target provides authentication data to the software application before document 1100 is opened. Once the target is authenticated, document 1100 is opened and encrypted text associated with the target is automatically decrypted.

The target decrypts those sections of the document for which the target has a section key, for example, section 1.0 contents 1101 and section 2.0 contents 1103 and thereby has access to all sections of the document that are unsecured—in plain text, for example section 3.0 contents 1105—and those secured for the target's access, for example section 1.0 contents 1101 and section 2.0 contents 1105, wherein the section key is secured with the target's secret key 1104. By placing the plain text in a separate window, a greater amount of control over the plain text exists than would be the case with an off the shelf document viewing application such as Adobe Reader® or Microsoft Word®. Optionally, all of the encrypted sections within the document accessible by the target are decrypted and shown in overlay windows in response to a same single target action. Once sections 1.0 and 2.0 contents are unsecured the target prints document 1100. However, section 4.0 contents 1106 is secured with section key 1107 and is other than decrypted. When document 1100 is printed section 4.0 contents 1106 is unreadable and thus a complete leak of the document 1100 contents is averted. Further, should the target decide to leak electronic document 1100 as received, the secure sections remain secure. The unsecured plain text section 3.0 content is readable by all targets, including targets other than having a section key. Once a section of text is decrypted the text is no longer secure. Optionally, document 1100 comprises unencrypted plain text that is readable by all targets, including targets other than having a section key. Optionally, decrypted text is legible text for reading by the target on the display. Optionally, when printing a secure document wherein a secure section is decrypted and displayed, the secure section is printed encrypted. Further optionally, when printing a secure document wherein a secure section is decrypted and displayed, the decrypted secure section is other than printed.

Alternatively, section keys are obviated and each section is secured any number of times for access by each of the targets using their secret keys. Of course, when a large group of targets exists, such a process will render the document unnecessarily large. Further, when a section key is used, adding or removing of targets is straightforward for those that have access to the section key and have permission to modify the document access privileges. Because only the section key need be re-ciphered, adding targets and similarly deleting a particular ciphered section key to remove targets is simplified.

When a document is restricted to purely electronic use or to only being printed in secured form, security can be maintained and monitored such that accessing any significant amount of data can be greatly limited or prevented. Further, by restricting documents to electronic form, document management and tracking is simplified.

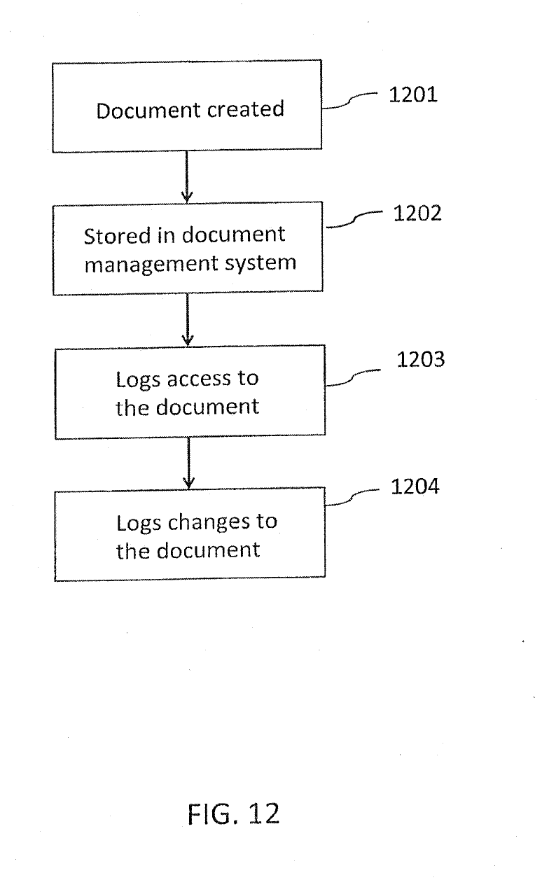

Referring to FIG. 12, shown is simplified flow diagram for a process for document management of a secure document such as that of FIG. 6 is shown. A document is created 1201. The document is stored in the document management system 1202. When the document is opened, a document management system logs the access to the document 1203. When the document is changed, the changes are logged 1204. As such, the document is tracked in content, security, access privileges, and time. Because of the security process employed, the document is secured at each stage and changes that are tracked are stored in a secured fashion one document relative to another, accessible only to those targets having access to those sections changed. Such a process allows more than one individual to work on a document where none or few of the individuals has access to the entire document.

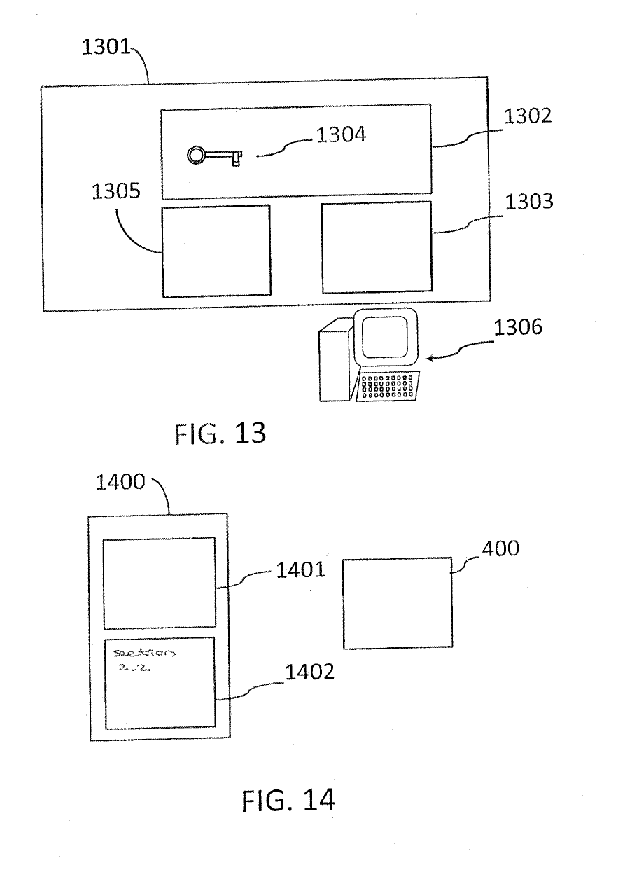

Referring to FIG. 13, shown is a simplified block diagram of a system for enhanced security of a target's secret key. A secure electronic device 1301 comprises a memory store 1302 and a processor 1303. Within the memory store is stored secret key 1304 associated with the target of the electronic device 1301. The electronic device 1301 comprises a target authorization circuit 1305 for receiving target authorization data and for authorizing the target thereof. The processor 1303 comprises suitable programming for performing cipher functions on data to transform said data from plain text to cipher text and from cipher text to plain text. By providing the processor 1303 with suitable programming, the target's secret key 1304 never needs to leave the secure electronic device 1301 and therefore security is more easily managed.

In use, the target couples the secure electronic device 1301 to a host computer system 1306. When the target requests deciphering of a section, the section is provided to the secure electronic device 1301 wherein it is deciphered. Optionally, the secure electronic device 1301 comprises a display for displaying the deciphered section. For example the secure electronic device comprises a tablet such as a Playbook® or an iPad®. Further optionally, the entire secure document is provided to the secure electronic device 1301 for deciphering and display thereon.

Alternatively, secure electronic device 1301 interfaces with a secure process on the host computer 1306 to provide any plain text resulting from decryption of secure sections thereto for secure display to the target on a display of the host computer 1306. This has advantages when secure electronic device 1301 is absent an integrated display. Further alternatively, the secure electronic device interfaces with another process on the host computer.

Alternatively, the secure electronic device 1301 provides the target's secret key 1304 to the host computer 1306 for use in ciphering operations. Of course, when the target secret key 1304 is provided from the secure electronic device 1301 to the host computer 1306, a risk of compromise of the key security increases.

Referring to FIG. 14, shown is a simple method for reading document 400 of FIG. 4. A digital device 1400 having a camera 1401 is used to image the page of the document 400. The digital device 1400 then performs image-to-text processing to extract text from the page and decodes the secured contents, for example section 2.2, and displays the document in an other than secured fashion for the target, for example on the screen 1402 of the digital device 1400. In such a fashion, the text, though readable to the end target, is neither printable by the target nor does the plain text form part of document 400. Thus, the overlay content of the embodiment of FIG. 11 is now displayed on the screen of a digital device, for example screen 1402. Such a device, when provided with the target's secret key is optionally provided as a secure device from which the secret key and the secret data that is decrypted cannot be extracted.

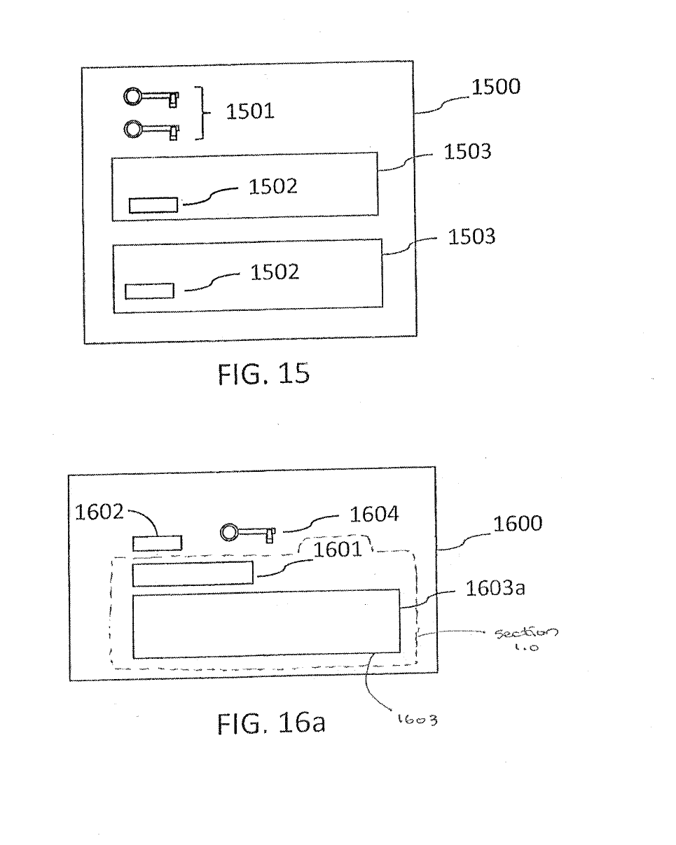

Referring to FIG. 15, shown is a document 1500 wherein section keys 1501 are secured and stored at a single location within document 1500. Each section 1503 has an indication of which section key is used to encrypt same. A process decrypts the section keys 1501 relying on a target secret key and then accesses those accessible sections within the document. Such a process allows for encryption of sections of the document that are other than contiguous and reduces a number of operations performed in decrypting section keys 1501 and then decrypting associated sections 1503.

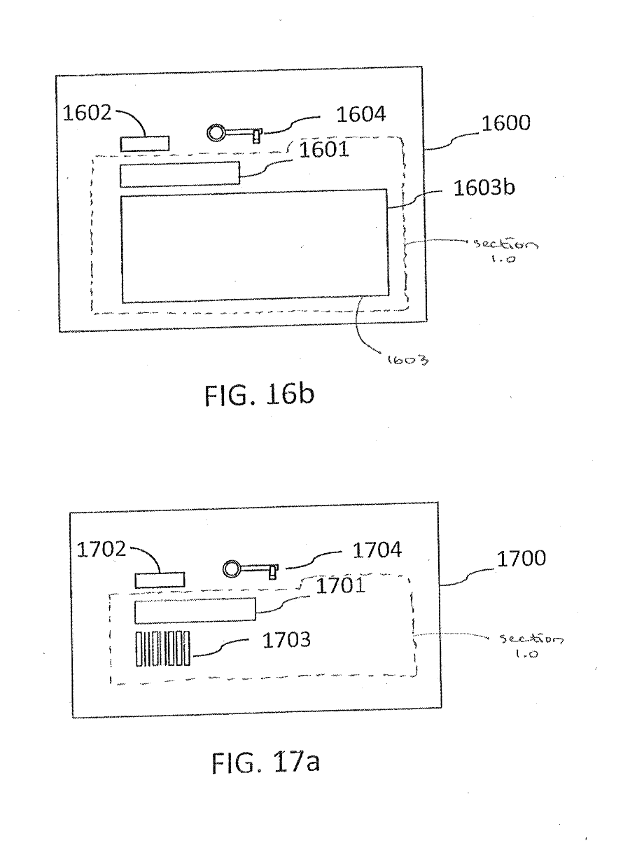

According to an embodiment of the invention, a secure section of a document is represented by a non-textual graphical image. For example, referring to FIG. 16a, shown is secure document 1600 comprising a secured section, section 1.0, section 1.0 heading 1601, target identifier 1602, section key 1604 and section 1.0 contents 1603. Similar to the embodiments described above, section 1.0 contents 1603 is encrypted by section key 1604 and is stored in document 1600. However, in contrast to the embodiments described above, section 1.0 contents 1603 appear as a non-textual graphical image, for example, as a picture. Alternatively, the non-textual graphical image comprises dots and dashes.

A non-textual graphical image representing encrypted text consumes less space within a document in comparison to a textual or ASCII character representation. For example, the length of the unsecured in document 1600 is 5 pages. Encrypting section 1.0 contents 1603 and storing a textual or ASCII character representation of same in document 1600, consumes more space than 5 pages, such as shown in FIG. 16b. A contributing factor to this size increase is that the overhead is due to an encryption process that is used, for example, advanced file encryption (AES), or data encryption standard (DES). Images displayed on a computer screen comprise a plurality of pixels wherein each pixel is defined by 16 bits or more, and ASCII characters are defined as 16 bits. When displayed on a computer screen, the size of a pixel is significantly smaller than the size of an ASCII character, which is made up of a plurality of pixels. Consequently, representing encrypted text in a non-textual graphical form consumes much less space than ASCII characters. For example, FIG. 16a shows the size of encoded section 1.0 contents 1603a represented by an image which is significantly smaller than section 1.0 contents 1603b represented by ASCII characters in FIG. 16b. Furthermore, much less space is consumed by a non-textual graphical image than by the unsecured text itself. Preferably, the image is formatted in dependence upon a method of reading the image. When the image is to be read from the electronic file itself, dense packing of data is easily supported. When the image is to be scanned optically, data is arranged to support error detection and correction of the scanned image to allow for decoding of the cipher data.

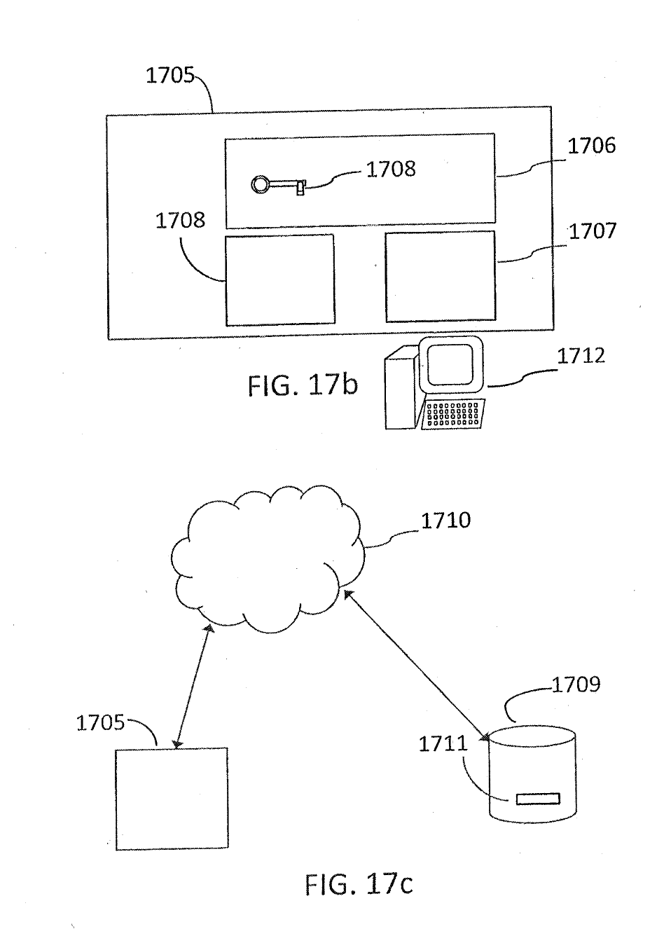

According to another embodiment of the invention, a secure section of a document is represented by a non-textual graphical image in the form of a barcode. For example, referring to FIG. 17a, shown is secure document 1700 comprising a secured section—section 1.0, section 1.0 heading 1701, target identifier 1702, section key 1704 and section 1.0 contents. Similar to the document 1600 in FIG. 16a, document 1700 section 1.0 contents is encrypted by a section key, section key 1704, and is stored in document 1700 as a non-textual graphical image in the form of a one dimensional bar code 1703. Alternatively, the barcode is a two dimensional bar code. Barcodes are spatially small yet comprise large amounts of data and are effectively and efficiently machine readable. Alternatively, the section 1.0 contents 1703 comprise an image and encoded text. Using the section key 1704 the section 1.0 contents, both image and text, are decoded.

Optionally, the non-textual graphical image, when decoded, is an address to a file located on a server containing section 1.0 contents and is viewable by the user.

Referring to FIG. 17b, shown is a simplified block diagram of a system for enhanced security of a target's secret key. A secure electronic device 1705 comprises a memory store 1706 and a processor 1707. Within the memory store is stored secret key 1708 associated with the target of the electronic device 1705. The electronic device 1705 comprises a target authorization circuit 1708 for receiving target authorization data and for authorizing the target thereof. The processor 1707 comprises suitable programming for performing cipher functions on data to transform said data from plain text to cipher text and from cipher text to plain text. By providing the processor 1707 with suitable programming, the target's secret key 1708 never needs to leave the secure electronic device 1705 and therefore security is more easily managed.

Referring to FIG. 17c, shown is a simplified block diagram of a system including remote access of a secure document. In use, the target couples the secure electronic device 1705 to a host computer system 1712. When the target requests deciphering of a barcode 1703, the section is provided to the secure electronic device 1705 wherein the electronic device provides image-to-text processing. Deciphered barcode 1703 comprises a link to remote server 1709 wherein document 1705 secured data is stored. Device 1705 retrieves encrypted text 1711 associated with barcode 1703 from server 1702 via secure communication network 1710. Optionally, the secure electronic device 1705 comprises a display for displaying the deciphered section. For example the secure electronic device comprises a tablet such as a Playbook® or an iPad®. Further optionally, the entire secure document is provided to the secure electronic device 1705 for deciphering and display thereon. Optionally, the target other than has direct access to server 1709. Further optionally the target is unaware of where server 1709 is located. Alternatively, secure electronic device 1705 interfaces with a secure process on the host computer 1712 to provide any plain text resulting from decryption of secure sections thereto for secure display to the target. Alternatively, the target decrypts document 1700 using the methods described in reference to FIG. 13.

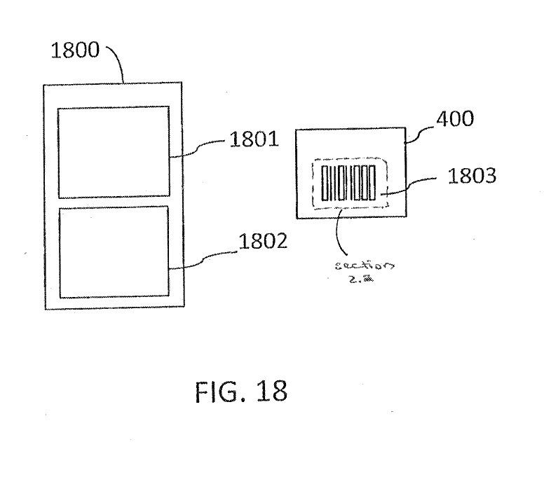

Referring to FIG. 18, shown is a simple method for reading document 400 of FIG. 4, wherein section 2.2 contents comprises a non-textual graphic image in the form of barcode 1803. A digital device 1800 having a camera 1801 is used to image the page of the document 400. The digital device 1800 then performs image-to-text processing to extract text from the page and decodes the secured contents, for example section 2.2, and displays the document in an other than secured fashion for the target, for example on the screen 1802 of the digital device 1800. In such a fashion, the text, though readable to the end target, is neither printable by the target nor does the plain text form part of document 400. Thus, the overlay content of the embodiment of FIG. 18 is now displayed on the screen of a digital device, for example screen 1802. Such a device, when provided with the target's secret key is optionally provided as a secure device from which the secret data that is decrypted cannot be extracted.

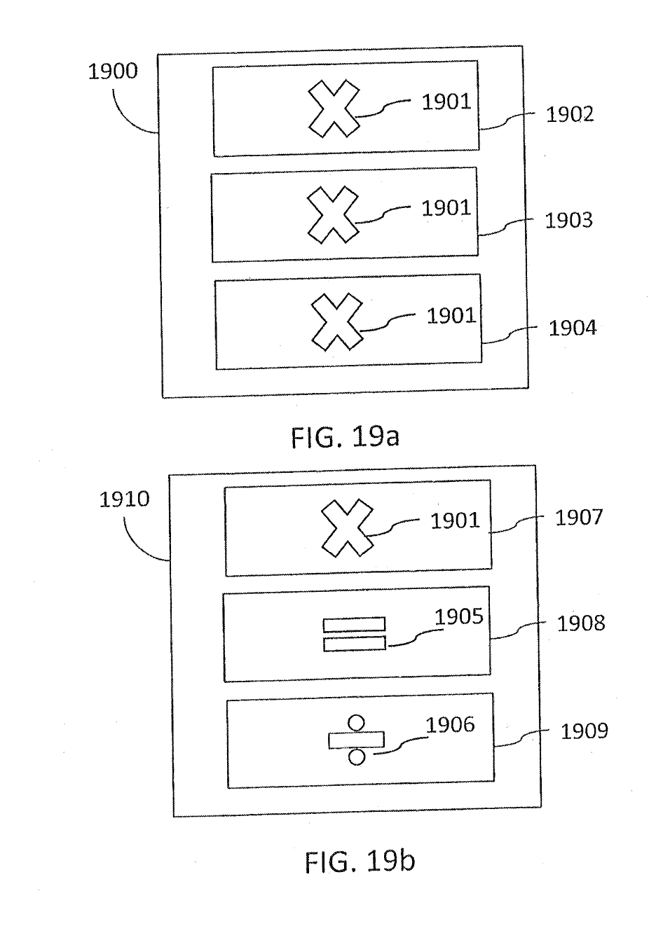

According to an embodiment of the invention secure documents comprise watermarks for document identification. FIG. 19a shows secure document 1900 comprising secured sections 1902, 1903 and 1904 and each section comprises watermark 1901. When any one of sections 1902-1904 are decoded watermark 1901 remains visible in the decoded section, for example the watermark 1901 related to the identification of the target. If any section of document 1900 is leaked, watermark 1901 will aid in the identification of the leaker, as only targets with access to the secure document could leak it. Alternatively, the watermark merely indicates an origin of the ciphered section that dissemination thereof is monitorable.

According to an embodiment of the invention secure documents comprise watermarks for identification of sections of a document. FIG. 19b a shows secure document 1910 comprising secured sections 1907-1909 each comprising a watermark 1901, 1905 and 1906, respectively. When any one of sections 1907-1909 are decoded the corresponding watermark remains visible in the decoded section. If any section of document 1900 is leaked, the watermark will aid in the identification of the section leaked and the leaker, as only targets with access to that secure section could leak it.

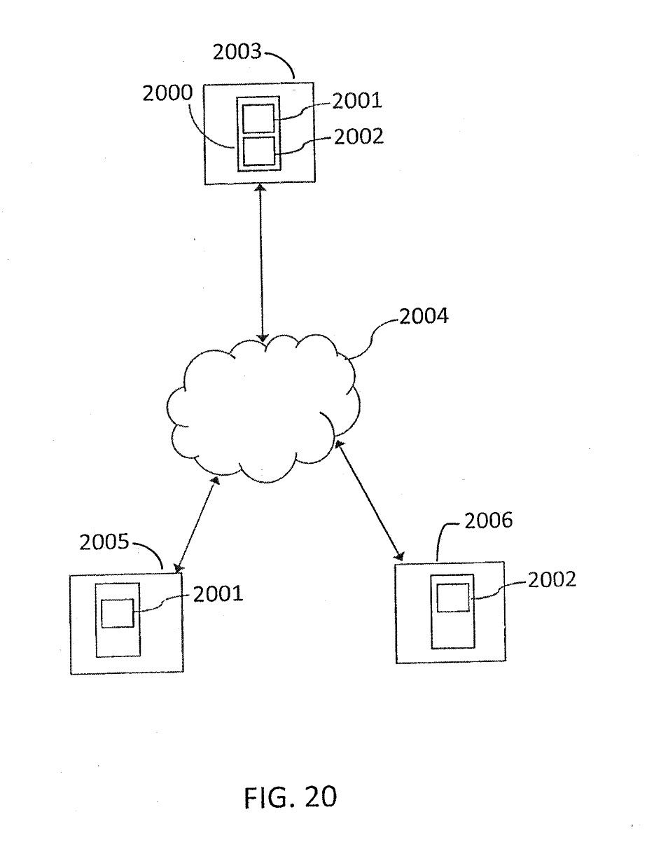

Referring to FIG. 20, shown is a prior art system for sharing a document. Document 2000 is stored on computer system 2003 and comprises two sections, a first section 2001 intended for the confidential use of a first user and a second section 2002 intended for the confidential use of a second user. Document 2000 is sent from system 2003 to remote systems 2005 and 2006 for access by the first and the second user via the communication network 2004. The confidential sections of document are accessible to unauthorized users. For example, the first user has access to the second section 2002 and the second user has access to the first section 2001. Alternatively, to ensure that the confidential sections of document 2000 are accessible to authorized users only, document 2000 is divided into two separate files the first comprising section 2001 and the second comprises section 2002. Computer system 2003 sends the first document to remote computer system 2005 and the second document to system 2006 via communication network 2004. Sending two separate documents ensures authorized users only have access to the specific confidential information.

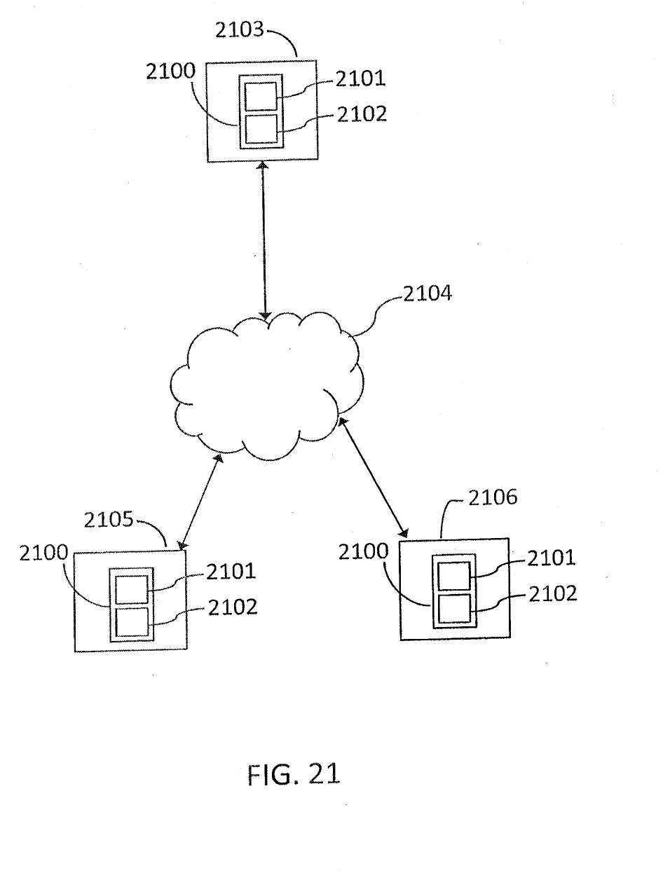

Referring to FIG. 21, shown is a system for sharing a secure document according to an embodiment of the invention. Document 2100 is stored on computer system 2103 and comprises two sections, a first section 2101 intended for the confidential use of a first user and a second section 2102 intended for the confidential use of a second user. The first section and the second section are encrypted via a first and second session key respectively. To prevent the first user from accessing the second section 2102 of document 2100, the second section 2102 is associated with the second user and the second session key is encrypted with the second user's public key. Similarly, to prevent the second user from accessing the first section 2101 of document 2100, the first section 2101 is associated with the first user and the first session key is encrypted with the first user's public key. Document 2100 is transmitted to remote systems 2105 and 2106, respectively, via communication network 2104. Upon receiving document 2100 by the remote system 2105, the first section is decrypted relying upon the first user's private key. However, the second section is other than decrypted as the first user has other than access to the second user's private key. When document 2100 is viewed by the first user, the first section is unsecured and readable whereas the second section is encrypted and unintelligible.

Similarly, upon receiving document 2100 by the remote system 2106, the second section is decrypted relying upon the second user's private key. However, the first section is other than decrypted as the second user has other than access to the first user's private key. When document 2100 is viewed by the second user, the second section is unsecured and readable whereas the first section is encrypted and undecipherable. Optionally, document 2103 comprises an unsecured section and all users having access to the document 2103 has access to the unsecured section, including user's that have other than a private key.

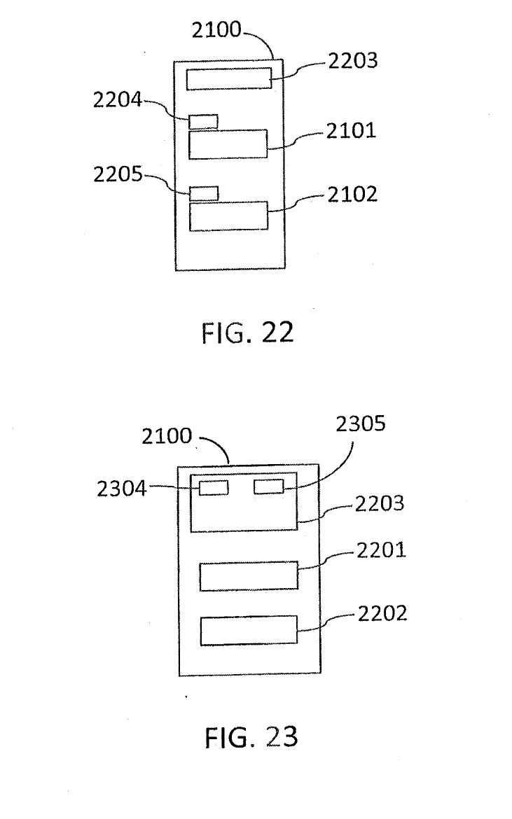

Referring to FIG. 22, shown is a simple block diagram of a system for generating the document of FIG. 21. Document 2100 is generated according to the prior art. Once document 2100 is generated, or during generation thereof, the first section 2101 is associated with the first user and the second section is associated with the second user. A first section key is generated for the first user and a second section key is generated for the second user for securing the first and second sections, respectively. The first user has exclusive access to first section 2101 and the second user has exclusive access to second section 2102. Once the first and second sections are encrypted and stored in document 2100, the first section key 2204 is then encrypted with the first user's public key or symmetric private key and stored within document 2100 immediately preceding the section it secures, the first section 2101. Similarly, the second section key 2205 is encrypted with the second user's private key and stored within document 2100 immediately preceding second section 2102. Once all sections of document 2100 are secured, it is shared with both users. When document 2100 is received by the first user the first section 2101 is decrypted and the second section 2102 remains encrypted. When document 2100 is received by the second user the second section 2102 is decrypted and the first section 2101 remains encrypted. Secured sections of a single document, wherein each secure section is accessible to a specific user, aids in management of the document. For example, document 2100, comprising a confidential section for a first user and another confidential section for a second user, need not be divided into two documents, the first document comprising the first section and a second document comprising the second section, to ensure that each confidential section remains accessible only to the intended user. Sharing one document minimizes the number of files that a file manager must keep track of when sharing secret data. Alternatively, the first user is a first user group wherein multiple users have the first user group private key and thus multiple users have access to the first section 2101.

Storing an encrypted section key immediately preceding the section with which it is associated, eases the process of copying a section from one document and pasting it into another. During the copying process, the section need not be searched for in other parts of a document as the encrypted section key and the section contents are spatially close to one another in the document. During the pasting process, the encrypted section key and the section contents are pasted into a second document and no other text of the document need to be modified. For example, in documents where encrypted section keys are located in the header, the header will be modified to include the new encrypted section key. Optionally a secure document comprises multiple sections that are accessible to a user or group of users. Further optionally, sections accessible to a user are contiguous. Further optionally, the sections accessible to user are non-contiguous. Optionally, the encrypted sections are stored in the document as a non-textual graphic image.

Shown in FIG. 23, is a simple block diagram of another method for generating the secure document in FIG. 21 according to an embodiment of the invention. Document 2100 is generated according to the prior art and comprises header 2203, first section 2101 and second section 2102. Once document 2100 is generated, or during generation thereof, the first section 2101 is associated with the first user and the second section is associated with the second user. A first section key is generated for the first user and a second section key is generated for the second user for securing the first and second sections, respectively. The first user has exclusive access to first section 2101 and the second user has exclusive access to second section 2102. Once the first and second sections are encrypted and stored in document 2100, the first section key is then encrypted with the first user's public key or symmetric private key and stored within first security data 2304 within header 2303 in document 2100. First security data also comprises the section number of the section it secures, for example, first security data comprises the encrypted first section key and reference to the first section. Similarly, the second section key 2305 is encrypted with the second user's public key or symmetric private key and stored within document 2300 and stored within second security data 2305 within header 2303 in document 2300. Second security data 2305 also comprises the encrypted second section key and reference to the second section. Optionally, document 2300 comprises a third section stored in plain text intended to be readable by any user, even users without an associated private cipher key.

Storing an encrypted section key and section number in a document header reduces processing during the decryption of a secured document. The secured document need not be completely analyzed for an encrypted section key and associated section. In contrast the header is searched for a section key and section number and only the section indicated in the section number is decrypted. Alternatively, multiple sections are encoded with the same section key and only the sections indicated in the section number are decrypted. Optionally, a secure document comprises multiple sections that are accessible to a user or group of users. Further optionally, sections accessible to a user are contiguous. Further optionally, the sections accessible to user are non-contiguous. Optionally, the encrypted sections are stored in the document as a non-textual graphic image.

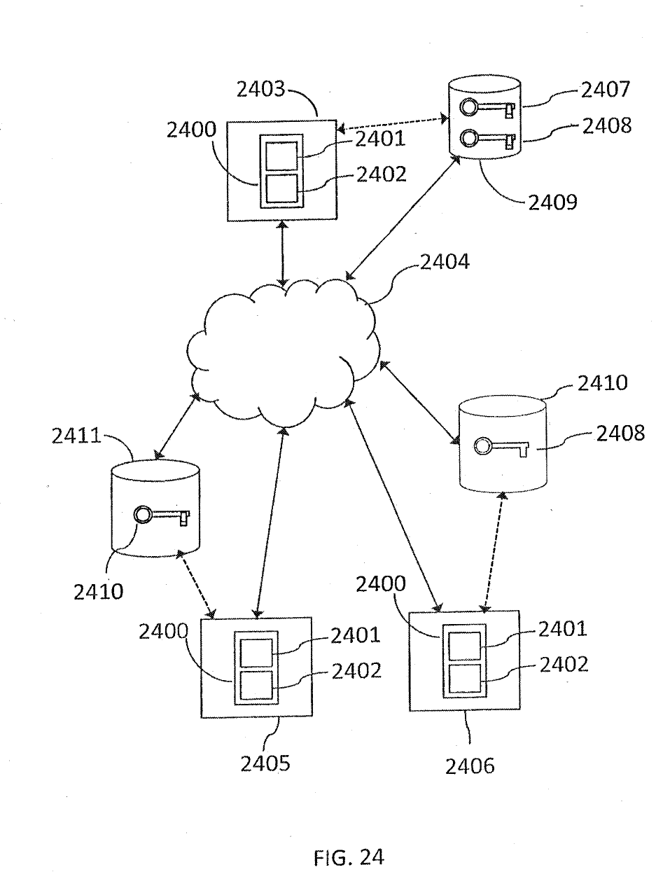

Referring to FIG. 24, shown is a simple network block diagram of a system for sharing a secure document according to an embodiment of the invention. Document 2400 is stored on computer system 2403 and comprises a first section 2401 and a second section 2402, wherein the first section 2401 is encrypted with a first section key 2407 and the second section is 2402 is encrypted with a second section key 2408. Computer system 2403 is coupled to communication network 2404 and to server 2409 wherein the section keys 2407 and 2408 are stored. Server 2409 transmits the first section key 2407 to server 2411 over a secure connection via network 2404 to which both servers are coupled. Server 2409 also transmits second section key 2408 to server 2410 over a secure connection via network 2404 to which server 2410 is coupled. Computer system 2403 transmits document 2400 to system 2405 and system 2406 via the communication network 2404 to which both systems are coupled. A first user opens up document 2400 for reading on system 2405. System 2405 retrieves first section key 2410 from server 2411 and the first section 2401 is decrypted whereas the second section 2402 is other than decrypted as the second section key 2408 is not available to the first user. A second user opens up document 2400 for reading on system 2406. System 2406 retrieves second section key 2408 from server 2410 and the second section 2402 is decrypted whereas the second section 2401 is other than decrypted as the first section key 2410 is not available to the first user. A predetermined key is associated with a unique user. Alternatively, a predetermined key is associated with a unique group of users. Keys are then transmitted to other servers and are other than embedded into secure documents.

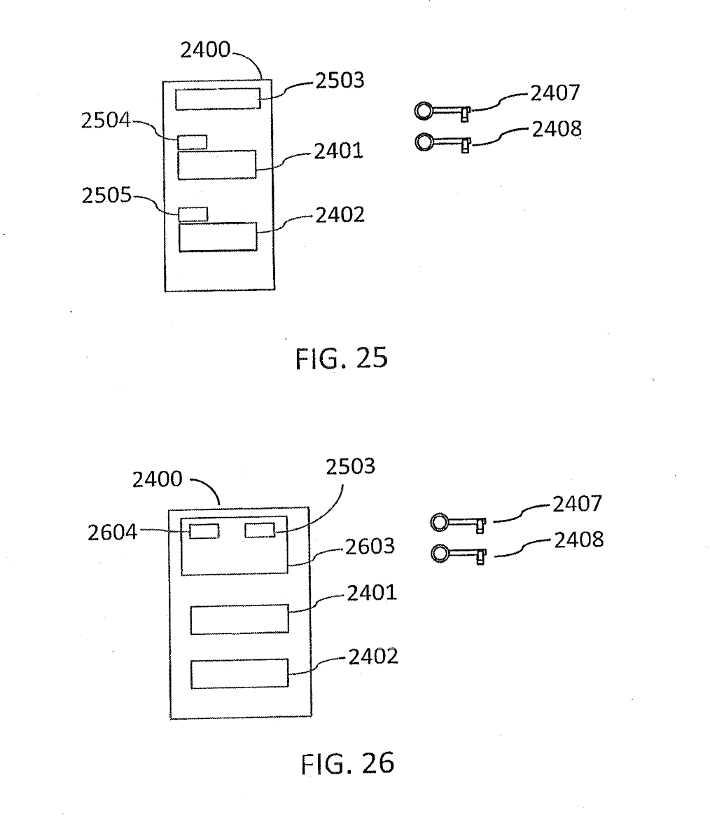

Referring to FIG. 25, shown is a method of generating and retrieving the secure document in FIG. 24 according to an embodiment of the invention. Document 2400 is generated according to the prior art and comprises header 2503, first section 2401 and second section 2402. Once document 2400 is generated, or during generation thereof, the first section 2401 is associated with the first user and the second section 2402 is associated with the second user. First reference data 2504 is generated for the first user for the first section in document 2400 and comprises an indication that the first user associated is with the first section 2401. Second reference data 2505 is generated for the second user for the second section in document 2400 and comprises an indication that the second user is associated with the second section 2402. The first user having exclusive access to first section 2401 and the second user having exclusive access to second section 2402. The first and second sections are encrypted with session keys 2407 and 2408, respectively, and stored in document 2400. Next, the first reference data 2504 stored within document 2400 immediately preceding the section it secures, the first section 2401. Similarly, the second reference data 2505 is stored within document 2400 immediately preceding the section it secures, the second section 2402. Once all sections of document 2400 are secured, the document is sent to both first and second users. For example, document 2400, comprising a confidential section for a first user and another confidential section for a second user, need not be divided into two documents, a first document comprising the first section and a second document comprising the second section, to ensure that each confidential section remains accessible only by the intended user. Sharing one document minimizes the number of files that a file manager must keep track of when sharing secret data. Alternatively, the first user is a first user group wherein multiple users have the first user group private key—a shared secret key—and thus multiple users have access to a first section.

When document 2400 is received by system 2405, the document is parsed for reference data. The first reference data 2504 is detected and the first user is identified as the intended recipient of the first section 2401. Session key 2407, unique to the first user, is retrieved from server 2411 and the first section is decrypted for reading by the first user whereas the second section 2402 remains encrypted and unintelligible. When document 2400 is received by system 2405, the second reference data 2505 is detected and the second user is identified as the intended recipient of the second section 2402. Session key 2408, unique to the second user, is retrieved from server 2410 and the second section 2402 is decrypted for reading by the second user whereas the first section 2401 remains encrypted and unintelligible.

Storing encrypted reference data immediately preceding the section with which it is associated, eases the process of copying a section from one document and pasting it into another. During the copying process, the encrypted section for the intended user need not be searched for in other parts of a document as the reference data and the section contents are spatially close to one another in the document. During the pasting process, the encrypted reference data and the section contents are pasted into a second document and no other text of the document need to be modified. For example, in documents where reference data are located in the header, the header will be modified to include the new encrypted session key. Optionally a secure document comprises multiple sections that are accessible to a user or group of users. Optionally, a revision number is stored in reference data and the session key retrieved from the server is dependent upon the user and the document revision number. Further optionally, sections accessible to a user are contiguous. Further optionally, the sections accessible to user are non-contiguous. Optionally, the encrypted sections are stored in the document as a non-textual graphic image.

Referring to FIG. 26, shown is another system for generating and retrieving the secure document in FIG. 24 according to an embodiment of the invention. Document 2400 is generated according to the prior art and comprises header 2503, first section 2401 and second section 2402. Once document 2400 is generated, or during generation thereof, the first section 2401 is associated with the first user and the second section 2402 is associated with the second user. First reference data 2504 is generated for the first user for the first section in document 2400 and comprises an indication of the first user associated with the first section 2401. Second reference data 2505 is generated for the second user for the second section in document 2400 and comprises an indication of the second user associated with the second section 2402. The first user having exclusive access to first section 2401 and the second user having exclusive access to second section 2402. The first and second sections are encrypted with session keys 2407 and 2408, respectively, and stored in document 2400. Next, the first reference data 2504 stored within document 2400 in header 2503 and comprises a reference to the first user and an indication of the associated section with the first user, the first section 2401. Similarly; header 2503 and comprises a reference to the second user and an indication of the associated section with the second user, the second section 2402. Once all sections of document 2400 are secured, it is sent to both first and second users. For example, document 2400, comprising a confidential section for a first user and another confidential section for a second user, need not be divided into two documents, a first document comprising the first section and a second document comprising the second section, to ensure that each confidential section remains accessible only by the intended user. Sharing one document minimizes the number of files that a file manager must keep track of when sharing secret data. Alternatively, the first user is a first user group wherein multiple users have the first user group private key—a shared secret key—and thus multiple users have access to a first section.

When document 2400 is received by system 2405, the header 2503 is searched for reference data. The first reference data 2504 is detected and the first user is identified as the intended recipient of the first section 2401. Session key 2407, unique to the first user, is retrieved from server 2411 and the first section is decrypted for reading by the first user whereas the second section 2402 remains encrypted and unintelligible. When document 2400 is received by system 2405, the header 2503 is searched for reference data. The second reference data 2505 is detected and the second user is identified as the intended recipient of the second section 2402. Session key 2408, unique to the second user, is retrieved from server 2410 and the second section 2402 is decrypted for reading by the second user whereas the first section 2401 remains encrypted and unintelligible. Optionally a secure document comprises multiple sections that are accessible to a user or group of users. Optionally, a revision number is stored in reference data and the session key retrieved from the server is dependent upon the user and the document revision number. Further optionally, sections accessible to a user are contiguous. Further optionally, the sections accessible to user are non-contiguous. Optionally, the encrypted sections are stored in the document as a non-textual graphic image.

Storing an encrypted session key and section number in a document header reduces processing during the decryption of a secured document. The secured document need not be completely analyzed for an encrypted session key and associated section. In contrast the header is parsed for a session key and section number and only the section indicated in the section number is analyzed. Alternatively, multiple sections are encoded with the same session key and only the sections indicated in the section number is analyzed.

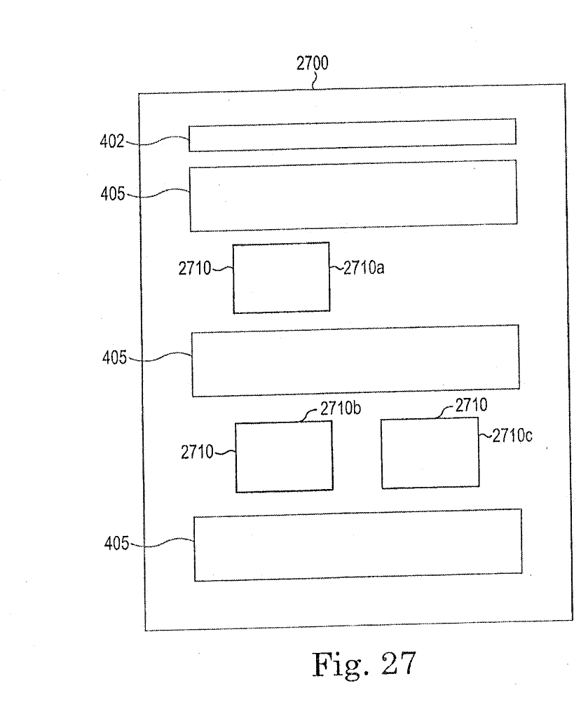

FIG. 27 shows a conceptual drawing of a printed document according to another embodiment.

In one embodiment, a printed document 2700 includes elements shown in the figure, including at least a title 402, one or more section contents 405, and one or more references 2710 to secured content. For example, references to secured content can include a first reference 2710a, a second reference 2710b, and a third reference 2710c. In the figure, the title 402 and the one or more section contents 405 are not encrypted or otherwise protected, with the effect that they are readable by anyone. The references 2710 to secured content are encoded so they refer to content located other than at the document, with the effect that the secure content is readable only by those who are able to decode those references 2710, retrieve that content, and decrypt or otherwise decode that content. This can have the effect that a first portion of the document 2700 is readable by anyone (for example, the title 402 and the one or more section contents 405), while a second portion of the document 2700 refers to content that is readable only by those who are authorized to do so (for example, the content referenced by the one or more references 2710 to secured content).

In the document 2700, the title 402 is optional. The number of section contents 405 can be arbitrarily selected. Even whether or not there are any section contents 405 is optional. For example, if there are no section contents 405, there would be no portion of the document that can be read by anyone, and authorization would be required to read any portion of the document. Additional elements can be optionally included in the document, such as section headings, subsection headings, subsection contents, footnotes, and otherwise.

In the document 2700, the number of references 2710 to secured content can be arbitrarily selected. Even whether or not there are any references 2710 to secured content is optional. For example, if there are no references 2710 to secured content, there would be no portion of the document that would require authorization to read, and the entire document would be available to be read by anyone. For each reference 2710 to secured content, the number and identity of users authorized to retrieve and view that content can be arbitrarily selected.

For example, secured content referenced by a first reference 2710a can be designated as readable by a class of users “A”, secured content referenced by a second reference 2710b can be designated as readable by a class of users “B”, and secured content referenced by a third reference 2710c can be designated as readable by a class of users “C”, where the classes of users “A”, “B”, and “C” can be arbitrarily selected, and might be distinct. In such examples, the classes of users can intersect, can be mutually exclusive, can have one class wholly contained within another, can have one class equal to another, or any other such logical relationship.

For example, a document 2700 might include a report targeted to investors, or prospective investors, in a particular company. That report might include sensitive information, such as salaries, budgets, product roadmaps, customers, and technology disclosure. Some parts of that document 2700 could be designated as public information. Those parts could be included in one or more section contents 405. However, some parts of that document 2700 could be restricted. Those parts could be secured content. In such examples, secured content referenced by a first reference 2710a could be designated as only readable by a class of users “A”, such as only those investors. In such examples, content referenced by a second reference 2710b could include salaries and budgets, and be designated as only readable by a class of users “B”, such as finance analysts. In such examples, content referenced by a third reference 2710c could include a product roadmap and technology information, and be designated as only readable by a class of users “C”, such as due diligence engineers. This has the effect that the same document 2700 can be made available to multiple reviewers, with distinct viewing privileges for different ones of those reviewers.

In one embodiment, the references 2710 to secured content can include QR codes, with the effect that those references 2710 can be viewed using a camera of a mobile device such as a cellular telephone, yet without taking up relatively large amounts of space on a printed page. The mobile device can image one or more QR codes, decode those QR codes using image recognition techniques, and use those references 2710 as described herein. In alternative embodiments, the references 2710 can include a bar code (such as sometimes found on product packaging), another graphical encoding, or another type of data encoding subject to automated recognition by a mobile device. In further alternative embodiments, the references 2710 can include data that is aided by human input for recognition, such as “captcha” text, math or word problems, or otherwise.

In one embodiment, each reference 2710 to secured content identifies an item of content that can be retrieved, such as from one or more remote servers, or from a cloud computing system. For a first example, a particular reference 2710 can describe or include a URL, a document in a file system, a database, a database search, or some other identifier of information that can be retrieved. For a second example, a particular reference 2710 can describe or include an identifier for any particular data item for which specific access control is desired, even such as a single formula in a spreadsheet table.

In alternative embodiments, the printed document 2700 can be represented in a computer memory (such as RAM, magnetic storage, optical storage, or another computer memory technology) in a form that document would have if it were printed, with the effect that the printed form of the document 2700 can be viewed by one or more users. This would have the effect that those users can view the title 402 and section contents 405, and any other unprotected information, but only authorized users can view secure content when there are references 2710 to secure content in the document. In the latter case, authorized users would be able to view the printed form of the document 2700, such as on a computer screen or using a projector, use a mobile device to recognize the graphical encoding of those references 2710, and access the associated secured content.

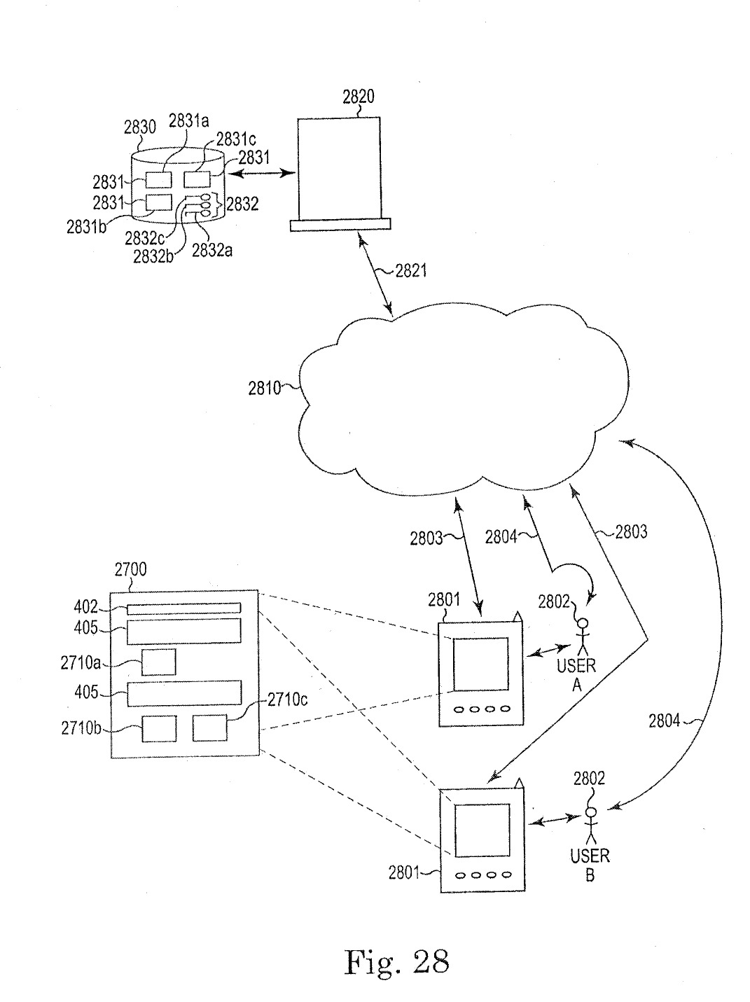

FIG. 28 shows a conceptual drawing of a system capable of retrieving secure content.

In one embodiment, document 2700, including its title 402, section contents 405, and references 2710 to secured content, is printed or otherwise accessible to mobile devices 2801 operated by users 2802. In the figure, a first user 2802 “A” has a first set of authorization rights to view particular secured content, while a second user 2802 “B” has a second set of authorization rights to view particular secured content. In the figure, each user 2802 can photograph (or make a video of) the document 2700, decode the references 2710, and communicate those decoded references 2710 using a secure communication pathway 2803 to a communication network 2810. For example, the communication network 2810 can include the Internet and the secure communication pathway 2803 can include an HTTPS or SSL communication protocol, or a communication protocol using an asymmetric-key or symmetric-key cryptosystem.

In one embodiment, the communication network 2810 routes messages between each user's mobile device 2801 and one or more remote servers 2820, or similarly, between each user's mobile device 2801 and a cloud computing system. The one or more remote servers 2820 are coupled to the communication network 2810 using a second secure communication pathway 2821, which can operate in a similar manner as the secure communication pathway 2803.

In one embodiment, the one or more remote servers 2820 can access a data repository 2830 including one or more items of secure content 2831, such as secure content 2831a described by reference 2710a, secure content 2831b described by reference 2710b, or secure content 2831c described by reference 2710c. The one or more remote servers 2820 can also access, in the data repository 2830, one or more keys 2832, such as key 2832a associated with secure content 2831a, key 2832b associated with secure content 2831b, or key 2832c associated with secure content 2831c.

In one embodiment, the keys 2832 can be used by the one or more remote servers 2820 to decrypt or decode the secure content 2831. For a first example, the keys 2832 can be used by the one or more remote servers 2820 to verify the identity of users 2802, such as by the one or more remote servers 2820 requiring users 2802 to present matching elements (whether asymmetric or symmetric) associated with the keys 2832. For a second example, the keys 2832 can each identify a secure hash of a password assigned to their associated secure content 2831. In such cases, one such secure hash could be SHA3 (although other secure hash codes would also work, and be within the scope and spirit of the invention). For a third example, the keys 2832 can be embedded in the references 2710 and can be used by the one or more remote servers 2820 to verify the identity of users 2802, such as by the one or more remote servers 2820 requiring users 2802 to present matching elements (whether asymmetric or symmetric) associated with the keys 2832, or such as the keys 2832 including information to decrypt the secure content 2831. For a fourth example, the keys 2832 can include human-readable references, such as uniform resource locators (URLs), “captcha” codes (that is, distorted test readable by a human being but not easily readable by a computer), math or word problems, or other indicators that the user 2802 themself is actually using the reference 2710.

In one embodiment, the users 2802 can each communicate with the one or more remote servers 2820 to authenticate themselves, that is, to verify that they are authorized to access the secure content 2831 identified by the reference 2710. For a first example, the users 2802 can enter a password or other identifying information using their mobile device 2801. For a second example, the users 2802 can use a secondary communication pathway 2804 to enter authenticating information. For a third example, the users 2802 can use a feature of their mobile device 2801 to authenticate, such as a telephone number associated with the mobile device 2801 when the mobile device 2801 includes a smartphone.

In one embodiment, the users 2802 can authenticate themselves to the one or more remote servers 2820 using shared secrets (such as passwords or otherwise), using biometric information (such as fingerprints, facial recognition, voiceprints, or otherwise), using a secondary device (such as a secure USB memory, an alternative mobile device, or otherwise), or using another technique.

In one embodiment, when the one or more remote servers 2820 are able to authenticate a particular user 2802, the remote servers 2820 can send the secure content 2831 to that authenticated user 2802 in a readable form. For a first example, the remote servers 2820 can decrypt (or decode) the secure content 2831 and send the decrypted secure content 2831 to that user's mobile device 2801 for viewing. For a second example, the remote servers 2820 can send the secure content 2831, still in encrypted form, along with a decryption key (such as the key 2832 assigned to that secure content 2831) to that user's mobile device 2801, with the mobile device 2801 performing the task of decryption of the secure content 2831 for viewing.

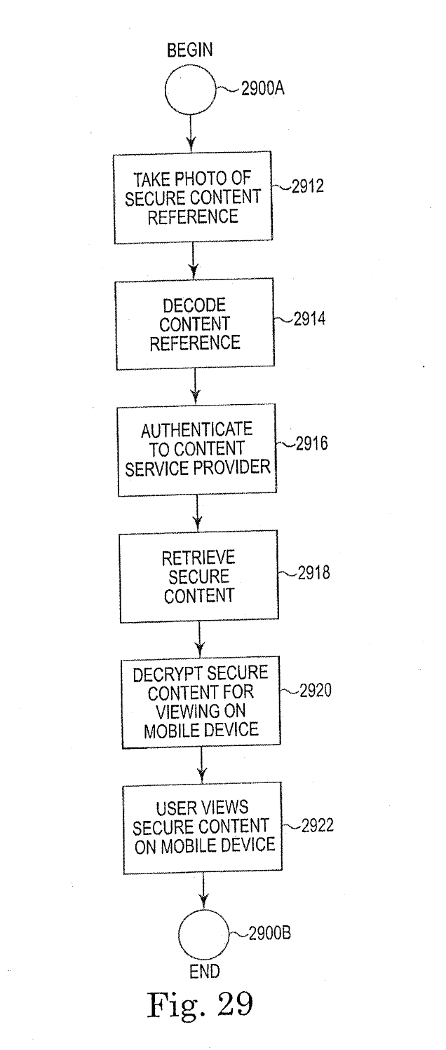

FIG. 29 shows a conceptual drawing of a method of retrieving secure content.

In one embodiment, a method 2900 includes a set of flow points and method steps. In one embodiment, the method steps can be performed in an order as described herein. However, in the context of the invention, there is no particular requirement for any such limitation. For example, the method steps can be performed in another order, in a parallel or pipelined manner, or otherwise.

In this description, where the “method” is said to arrive at a state or perform an action, that state is arrived at, or that action is performed, by one or more devices associated with performing the method. In one embodiment, the method can be performed, at least in part, by the one or more mobile devices 2801, the one or more remote servers 2820, and the one or more data repositories 2830. In alternative embodiments, the method 2900 can be performed, in addition or instead, by one or more other devices, in a distributed system or otherwise. For example one or more such devices can operate in conjunction or cooperation, or each performing one or more parts of the method.

Similarly, although one or more actions can be described herein as being performed by a single device, in the context of the invention, there is no particular requirement for any such limitation. For example, the one or more devices can include a cluster of devices, not necessarily all similar, by which actions are performed. Also, while this application generally describes one or more method steps as distinct, in the context of the invention, there is no particular requirement for any such limitation. For example, the one or more method steps could include common operations, or could even include substantially the same operations.

METHOD BEGINS. A flow point 2900A indicates a beginning of the method 2900.

OBTAIN GRAPHICAL ENCODING. At a step 2912, the method 2900 obtains a graphical encoding of a particular reference 2710 to secure content. In one embodiment, as described herein, a particular user 2802 uses their mobile device 2801 (such as a smartphone) to take a photograph of the reference 2710. In one embodiment, as described herein, the graphical encoding can include a QR code.

DECODE CONTENT REFERENCE. At a step 2914, the method 2900 decodes the reference 2710 and identifies the secure content 2831 to which it refers. In one embodiment, the mobile device 2801 recognizes the QR code, decodes the QR code, and reformats the information described by the QR code to refer to a particular item of secure content 2831.

AUTHENTICATE USER. At a step 2916, the method 2900 authenticates the user 2802 to the one or more remote servers 2820. In one embodiment, as described herein, the user 2802 contacts the one or more remote servers 2820 using a second secure communication channel 2804, and presents information to the one or more remote servers 2820 enabling the latter to authenticate the user 2802 (such as a username and a password).

RETRIEVE SECURE CONTENT. At a step 2918, the method 2900 retrieves the secure content 2831 identified by the reference 2710. In one embodiment, the mobile device 2801 identifies the particular item of secure content 2831 to the one or more remote servers 2820, the one or more remote servers 2820 obtain that particular item of secure content 2831 from the one or more data repositories 2830 in an encrypted form, and the one or more remote servers 2820 send the secure content 2831 in its encrypted form to the mobile device 2801. In one embodiment, after authenticating the user 2802 as in the just-previous step, the one or more remote servers 2820 separately send the key 2832 associated with that particular item of secure content 2831 to the mobile device 2801.

DECRYPT SECURE CONTENT. At a step 2920, the method 2900 decrypts the secure content 2831 for viewing on the mobile device 2801 by the user 2802. In one embodiment, as described herein, the mobile device 2801, having both the encrypted particular item of secure content 2831 and its associated key 2832, decrypts that particular item of secure content 2831.

USER VIEWS SECURE CONTENT. At a step 2922, the method 2900 allows the user to view the secure content 2831 identified by the reference 2710. In one embodiment, the mobile device 2801 presents the particular item of secure content 2831 to the user 2802, such as using a display available at the mobile device 2801.

METHOD ENDS AND REPEATS. A flow point 2900B indicates an end of the method. In one embodiment, the method 2900 repeats so long as there are further requests for secure content 2831.

The embodiments presented are exemplary only and persons skilled in the art would appreciate that variations to the embodiments described above may be made without departing from the spirit of the invention. The scope of the invention is solely defined by the appended claims.

1. A secure document comprising:
a first secure section for being accessed by a first target, the first secure section having therein encrypted data displayable within the secure document and for forming part of the displayed secure document; and
a first security section for use in decrypting of the first secure section, the first security section having first section security data secured therein by first target security data, the first target security data accessible to the first target, and the first security section for being displayed within the secure document.

2. The secure document according to claim 1 wherein the secure document is a printed document.

3. The secure document according to claim 1 wherein the secure document is an electronic document.

4. The secure document according to claim 1 comprising:
a second secure section for being accessed by a second target, the second secure section having therein encrypted data displayable within the secure document and for forming part of the displayed secure document; and
a second security section for use in decrypting of the second secure section, the second security section having second section security data secured therein by second target security data, the second target security data accessible to the second target and the second security section for being displayed within the secure document.

5. The secure document according to claim 4 wherein the first secure section is other than accessible to the second target.

6. The secure document according to claim 4 wherein the second secure section is other than accessible to the first target.

7. The secure document according claim 6 comprising:
a third security section for use in decrypting of the second secure section, the third security section having second section security data secured therein by first target security data, the first target security data accessible to the first target and the third security section for being displayed within the secure document.

8. The secure document according to claim 1 comprising:
a plain text section comprising content that is unsecured for being displayed within the secure document.

9. The secure document according to claim 8 wherein the plain text section comprises legible content for being read by any target having access to the document.

10. The secure document according to claim 1 wherein the first security section comprises an indication of the first target.

11. The secure document according to claim 1 wherein the second security section comprises an indication of the second target.

12. The secure document according to claim 1 wherein the first secure section comprises a non-text graphic section, the non-text graphic section for encoding encrypted data, the encrypted data, when decrypted, forming an unsecure version of the secure section.

13. The secure document according to claim 12 wherein the unsecure version comprises an image.

14. The secure document according to claim 12 wherein the unsecure version comprises plain text for being read by the first target.

15. The secure document according to claim 12 wherein the unsecure version comprises plain text for being read by the first target and an image.

16. The secure document according to claim 1 wherein the first secure section comprises a non-text graphic section, the non-text graphic section for encoding encrypted data, the encrypted data, when decrypted, forming a link to stored data for insertion within the document, the link, when accessed, for initiating retrieval of the stored data and display of data in dependence thereon within the document.

17. The secure document according to claim 16 wherein the stored data is stored in a plain text form.

18. The secure document according to claim 16 wherein the stored data is stored in an encrypted form.

19. The secure document according to claim 16 wherein the stored data is stored remotely for communication to a local system in secure fashion in response to an access to the link.

20. The secure document according to claim 16 wherein the non-text graphic section comprises a barcode.

21. The secure document according to claim 20 wherein the barcode is for being scanned from a printed copy of the secure document.

22. The secure document according to claim 20 wherein the barcode is for being deciphered only from an electronic copy of the secure document.

23. The secure document according to claim 16 wherein the non-text graphic section comprises a visible watermark.

24. The secure document according to claim 1 wherein the first secure section comprises non-contiguous sections of the secure document secured together in a single secure section.

25. The secure document according to claim 1 wherein the first secure section and the first security section each comprise error correction data encoded therein.

26-74. (canceled)
